(19) United States
(12) Patent Application Publication
(10) Pub. No.: US 2014/0305349 A1
(43) Pub. Date: Oct. 16, 2014

(54) MOUNTABLE VEHICLE WORK SURFACE APPARATUS

(71) Applicant: AUTOEXEC, INC., GRAND RAPIDS, MI (US)

(72) Inventors: David T. Lippert, Grand Rapids, MI (US); Charles E. Lippert, Grand Rapids, MI (US); Bradley S. Abel, Clarksville, MI (US)

(21) Appl. No.: 14/249,667

(22) Filed: Apr. 10, 2014

Related U.S. Application Data
(60) Provisional application No. 61/810,571, filed on Apr. 10, 2013.

(51) Int. Cl. B60N 3/00

(52) U.S. Cl. CPC B60N 3/001
USPC 108/44

(57) ABSTRACT

A work surface assembly adapted for mounting within a vehicle includes a support assembly affixed to a telescoping arm assembly, with the telescoping arm assembly including an upper arm configured for telescopic movement relative to a lower arm whereby the support assembly may be raised and lowered. The support assembly includes a first support member that is horizontally oriented and slidingly mounted to the telescoping arm assembly whereby the first support member may be radially extended and retracted relative to the telescoping arm assembly.

### CROSS REFERENCE TO RELATED APPLICATION

The present application claims priority of U.S. provisional application Ser. No. 67/810,571 filed Apr. 10, 2013, which is hereby incorporated herein by reference in its entirety.

### BACKGROUND OF THE INVENTION

The present invention is directed to a mountable work surface apparatus, and in particular a work surface assembly mounted in a vehicle.

People regularly conduct business away from fixed locations such as offices or homes. In such cases, individuals such as utility workers, salespersons, contractors, truckers and delivery drivers frequently travel using motor vehicles to reach their contacts, work sites or destinations. Along with reaching remote locations, traveling by motor vehicle enables these individuals to transport many of the items they may need to conduct their business. By having such items in their vehicle, individuals are better equipped to efficiently and effectively conduct a broad scope of business without having to make multiple trips between the location of their business contacts and fixed business environments.

### SUMMARY OF THE INVENTION

The present invention provides a work surface apparatus for mounting within a vehicle to provide a work surface for an occupant of the vehicle.

According to an aspect of the present invention, a work surface assembly adapted for mounting within a vehicle comprises a support assembly affixed to a telescoping arm assembly, with the telescoping arm assembly including an upper arm configured for telescopic movement relative to a lower arm whereby the support assembly may be raised and lowered. The support assembly includes a first support member that is horizontally oriented and slidingly mounted to the telescoping arm assembly whereby the first support member may be radially extended and retracted relative to the telescoping arm assembly.

In the illustrated embodiment the support assembly is rotatable relative to the telescoping arm assembly. Still further, the work surface assembly may include a mounting plate connected with the upper arm with the first support member being mounted to the mounting plate, such as by way of one or more slide assemblies to enable the first support member to radially extend and retract relative to the telescoping arm assembly. A second support member may also be provided, such as a second support member that is moveable between a vertical or horizontal orientation and may be connected to the first support member by a hinge.

The telescoping arm assembly may further include a base plate distally located from the support assembly for mounting the work surface assembly in a vehicle, such as within a container. In such an embodiment a base sleeve may be fixedly connected to the base plate with the base sleeve configured to receive the lower arm of the telescoping arm assembly.

According to another aspect of the present invention a work surface apparatus comprises a container and a work surface assembly mounted within the container, where the container is mounted or is mountable within a vehicle. The work surface assembly comprises a support assembly affixed to a telescoping arm assembly and is telescopically moveable between a raised position in which the support assembly is positioned outside of the container and a lowered position in which the support assembly is positioned inside of the container. In the illustrated embodiment the support assembly includes a horizontally oriented first support member and that is slidingly mounted to the telescoping arm assembly whereby the first support member may be radially extended and retracted relative to the telescoping arm assembly.

The work surface apparatus of the present invention provides a convenient mechanism for supporting computers and other work materials that may be used by an occupant of a vehicle when the vehicle is not in motion. The computer and/or materials are properly positioned for easy access and use when the work surface assembly is in the raised position with the support member extended and rotated into position. When not in use, the support assembly may be completely lowered into and contained within the storage container, including locked away for safety purposes. The apparatus thus provides a suitable work surface that may be used across a wide range of industries, including service providers that travel to homes or businesses, such as delivery, repair and installation companies.

These and other objects, advantages, purposes and features of this invention will become apparent upon review of the following specification in conjunction with the drawings.

### BRIEF DESCRIPTION OF THE DRAWINGS

FIG. 1 is a perspective view of a work surface apparatus in accordance with the present invention mounted within a vehicle;

FIG. 2 is a perspective view of the work surface assembly of FIG. 1 removed from the vehicle;

FIG. 3 is an exploded perspective view of the work surface assembly of FIG. 2;

FIG. 4 is a perspective view of the storage container of FIG. 1 removed from the vehicle and shown without the cover;

FIG. 5 is a side elevation view of the storage container and work surface assembly of FIG. 1 shown removed from the vehicle;

FIG. 6 is a side elevation view of the storage container and work surface assembly of FIG. 5 shown with the cover in an open position;

FIG. 7 is a side elevation view of the storage container and work surface assembly of FIG. 5 shown with the work surface assembly in a raised position and a support member pivoted into an open position; and

FIG. 8 is a side elevation view of the storage container and work surface assembly of FIG. 5 shown with a support assembly slid into a driver engagement orientation.

### DESCRIPTION OF THE PREFERRED EMBODIMENTS

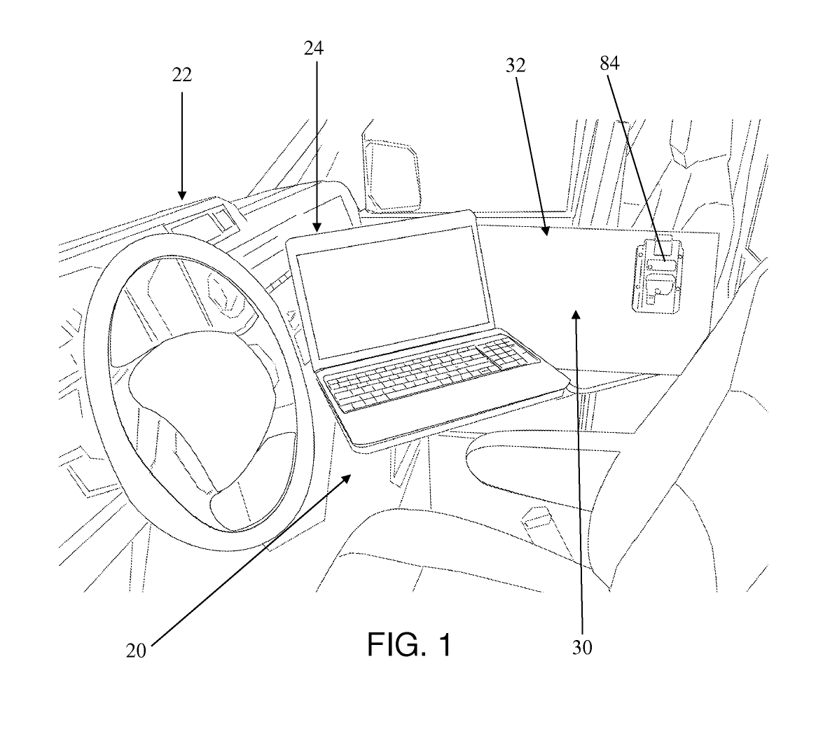

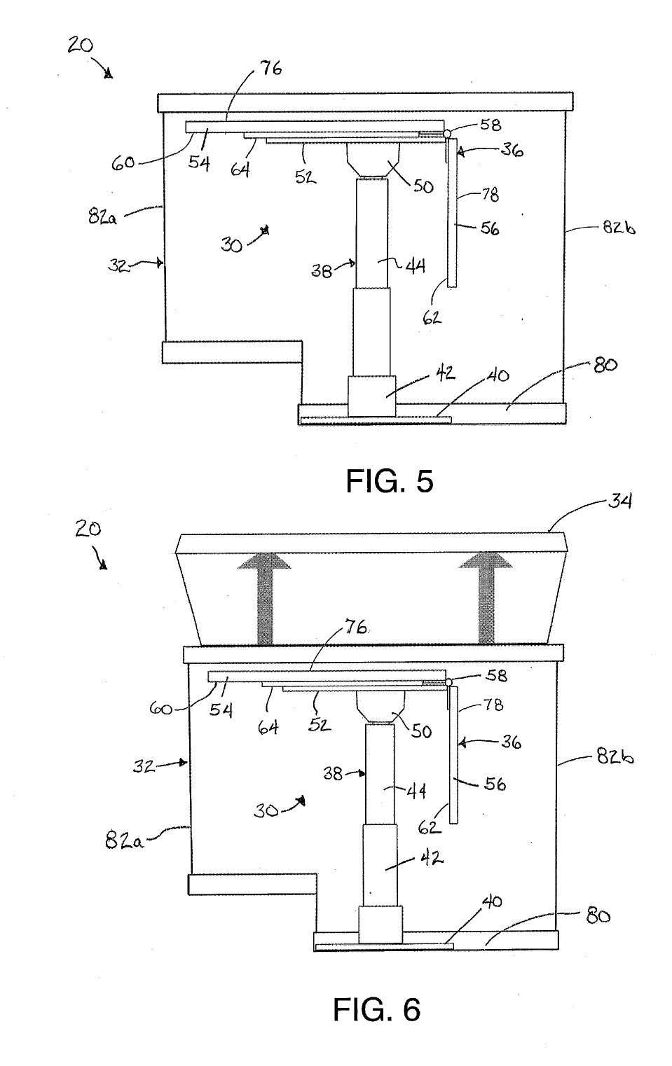

The present invention will now be described with reference to the accompanying figures, wherein the numbered elements in the following written description correspond to like-numbered elements in the figures. As shown in the embodiment of FIG. 1, the present invention is directed toward a work surface apparatus 20 that is mountable within a vehicle 22 to provide an occupant of the vehicle a convenient work area, such as for supporting a computer 24. Apparatus 20 includes a work surface assembly 30 mounted within a storage container 32 such as may be installed between driver and passenger seats within vehicle 22. Work surface assembly 30 is rotatable, and may also be raised and lowered relative to container 32, including to fully store work surface assembly 30 within container 32 whereby a cover or lid 34 of container 32 may be closed (see FIG. 5). As shown in FIG. 1, work surface assembly 30 includes a support assembly 36 that, when fully extended and rotated relative to container 32, provides a surface upon which an occupant of vehicle 22 may work.

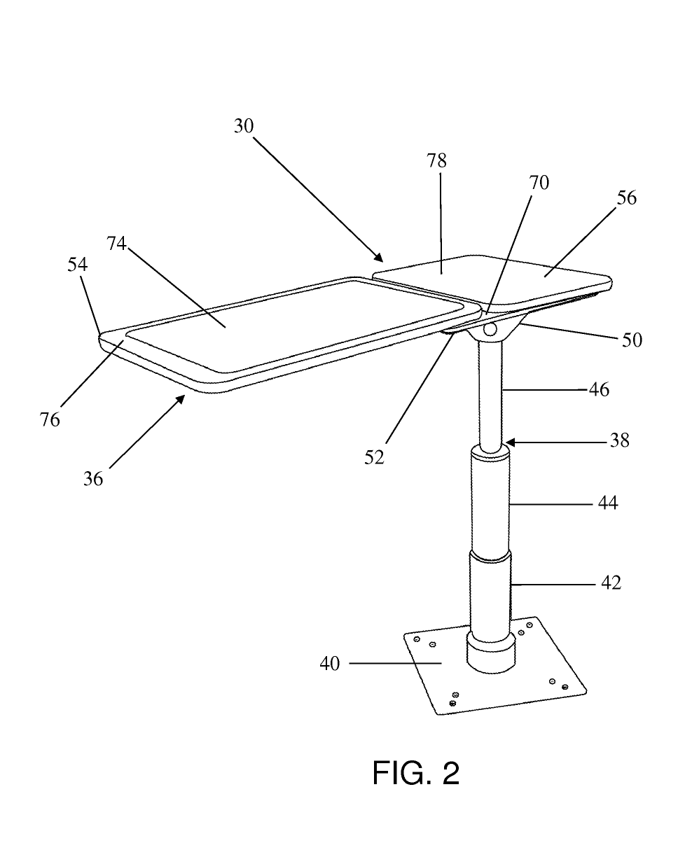

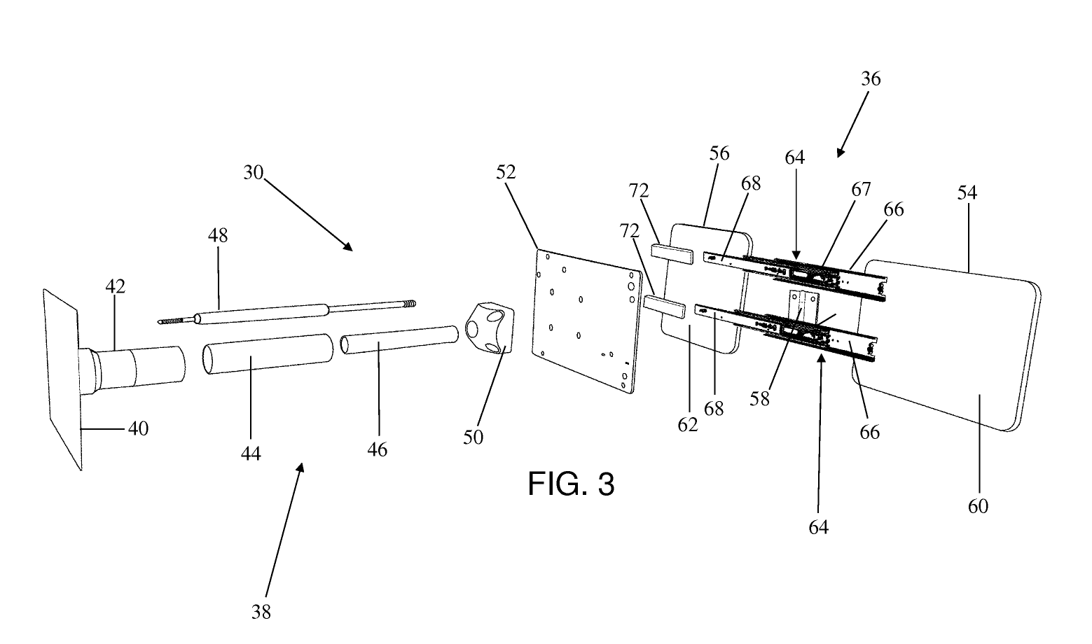

Referring now to FIGS. 2 and 3, work surface assembly 30 includes a rotatable telescoping arm assembly 38 to which support assembly 36 is secured, with arm assembly 38 being affixed to a base plate 40 that, as discussed in more detail below, is used to connect work surface assembly 30 to container 32. Arm assembly 38 includes a base sleeve 42 that is affixed to base plate 40, and includes a lower sleeve or arm 44 and an upper sleeve or arm 46 with a damper member 48 disposed within lower sleeve 44 and upper sleeve 46. In the illustrated embodiment, base sleeve 42 is immovably fixed to base plate 40 and receives lower sleeve 44 with lower sleeve 44 being rotatable within base sleeve 42. Still further, upper sleeve 46 is telescopically received within lower sleeve 44. The ends of damper member 48, which in the illustrated embodiment comprises a gas damper spring, are threaded and securable to lower sleeve 44 and upper sleeve 46 whereby damper member 48 enables upper sleeve 46 to telescope relative to lower sleeve 44, as well as retains upper sleeve 46 in an extended position when so desired. Still further, damper member 48 enables upper sleeve 46 to be lowered into lower sleeve 44, such as by a slight upward lifting on support assembly 36 when in the raised position to release damper member 48. Damper member 48 may comprise a gas damper spring supplied by Suspa, Inc. of Grand Rapids, Mich. Arm assembly 38 further includes a mounting block 50 that is press fit onto the distal end of upper sleeve 46, where mounting block 50 includes apertures to enable a mounting plate 52 to be secured thereto, such as by fasteners.

Support assembly 36 is secured to mounting plate 52 and comprises a pair of supports or support members 54, 56 functioning as support or work surfaces. The support members 54, 56 are connected together by a hinge 58 joined to the undersides or bottom surfaces 60, 62 of the support members 54, 56, respectively, where the hinge 58 allows the support member 54 to pivot relative to the support member 56. Support assembly 36 further includes a pair of slides or slide assemblies 64, where in the illustrated embodiment slides 64 comprise telescoping drawer slides. A first arm 66 of each slide 64 is affixed to the underside 60 of support member 54, and a second arm 68 of each slide 64 is affixed to the top surface 70 of mounting plate 52, with each slide 64 further including an inner arm 67 linking the first arm 66 and second arm 68 together for telescopic movement. In the illustrated embodiment slides 64 comprise conventional drawer slides.

Still further, a pair of glide blocks 72 (FIG. 3) are affixed to the bottom surface 62 of support member 56, where glide blocks 72 promote the pivoting and sliding movement of support member 56 relative to mounting plate 52, as discussed below. In the illustrated embodiment mounting plate 52 includes various mounting apertures for securing second arms 68 of slides 64 thereto, such as by fasteners. Likewise, bottom surface 60 of support member 54 includes mounting apertures for enabling first arms 66 of slides 64 to be secured thereto by fasteners.

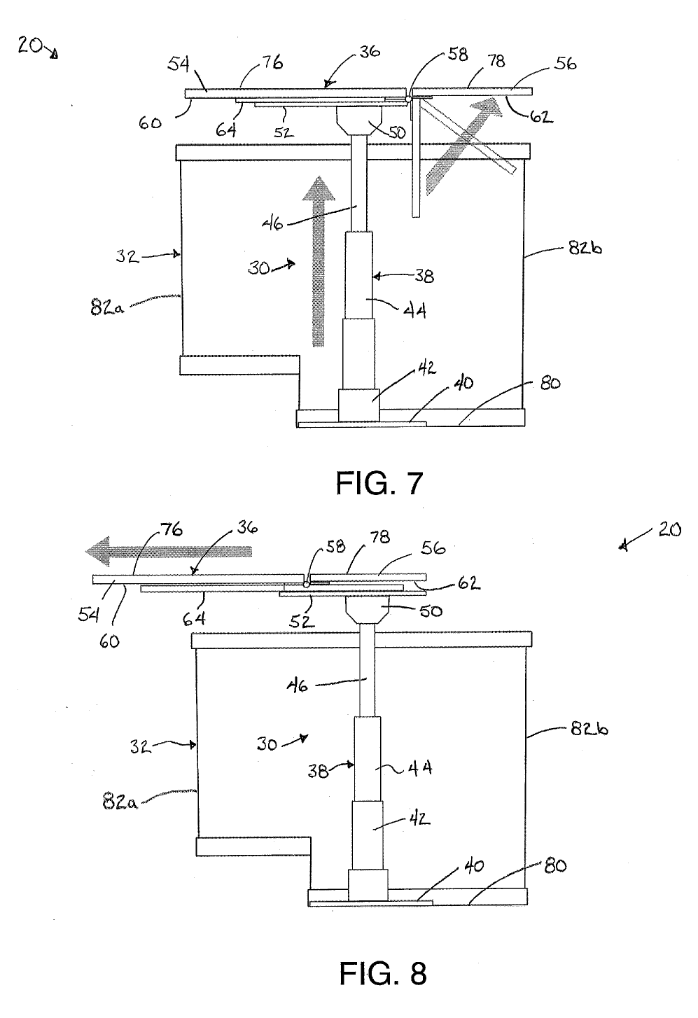

Support assembly 36 is thereby able to radially extend and retract relative to arm assembly 38. In particular, support member 54 may be slid outwardly relative to mounting plate 52 via slides 64 by a user after arm assembly 38 has been raised (see FIGS. 7 and 8). Simultaneously, due to the connection of support member 56 to support member 54 via hinge 58, support member 56 is pulled along by support member 54, with support member 56 pivoting upwardly from a vertical orientation into a horizontal orientation positioned over mounting plate 52. As understood from FIGS. 1 and 2, support member 54 further includes a pad 74 on the top or upper surface 76 of support member 54, where pad 74 may comprise a rubberized, non-slip pad for assisting in the retention of computer 24 thereon. The top or upper surface 78 of support member 56 is adjacently located computer 24 and may be used as a location for a mouse device (not shown) for operation of computer 24 and/or as a separate work surface. Although not shown in FIG. 5, computer 24 may remain on support member 54 when work surface assembly 30 is placed in the lowered or storage position of FIG. 5 within container 32.

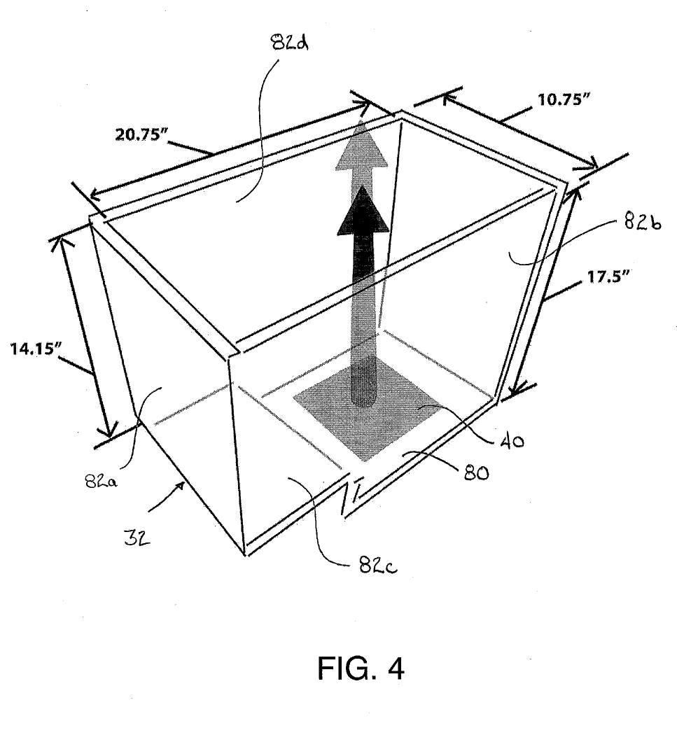

With further reference to FIGS. 4-8, container 32 includes a bottom 80 to which base plate 40 of work surface assembly 36 is affixed. In the illustrated embodiment, base plate 40 includes mounting holes whereby base plate 40 may be secured to container 32 via fasteners, such as bolts (not shown). The bolts may extend into or through support structure of vehicle 22, including passing through the floor of the vehicle. In addition to lid 34, container 32 further includes a front side 82a, rear side 82b, driver side 82c, and a back side 82d (see FIG. 4). Lid 34 also includes a latch 84, where latch 84 may be lockable to prevent theft or tampering when not in use.

In particular embodiments vehicle 22 comprises a van, such as may be used in various industries including delivery, installation, maintenance or repair service companies. It should be understood, however, that work surface apparatus 20 may be employed in alternative vehicles, including trucks. Still further, although work surface apparatus 20 is shown in connection with a laptop style computer 24 it should also be appreciated that work surface apparatus 20 may be used with alternative computing devices or even without a computer device.

Changes and modifications in the specifically described embodiments can be carried out without departing from the principles of the present invention which is intended to be limited only by the scope of the appended claims, as interpreted according to the principles of patent law including the doctrine of equivalents.

The embodiments of the invention in which an exclusive property or privilege is claimed are defined as follows:

1. A work surface assembly adapted for mounting within a vehicle, said work surface assembly comprising:
a support assembly affixed to a telescoping arm assembly, with said telescoping arm assembly including an upper arm configured for telescopic movement relative to a lower arm whereby said support assembly may be raised and lowered;
said support assembly including a first support member, said first support member being horizontally oriented and slidingly mounted to said telescoping arm assembly whereby said first support member may be radially extended and retracted relative to said telescoping arm assembly.

2. The work surface assembly of claim 1, wherein said telescoping arm assembly includes a mounting plate connected with said upper arm, and wherein said first support member is mounted to said mounting plate.

3. The work surface assembly of claim 2, further including a slide assembly, said slide assembly being connected to said mounting plate and said first support member to enable said first support member to radially extend and retract relative to said telescoping arm assembly.

4. The work surface assembly of claim 3, further including a second slide assembly connected to said mounting plate and said first support member.

5. The work surface assembly of claim 1, further including a second support member located adjacent said first support member, wherein said second support member may be vertically or horizontally oriented.

6. The work surface assembly of claim 5, wherein said second support member is connected to said first support member via a hinge.

7. The work surface assembly of claim 6, wherein said second support member is vertically oriented when said first support member is retracted relative to said telescoping arm assembly and is horizontally oriented when said first support member is extended relative to said telescoping arm assembly.

8. The work surface assembly of claim 1, wherein said telescoping arm assembly further includes a base plate distally located from said support assembly, said base plate adapted for mounting said work surface assembly.

9. The work surface assembly of claim 8, further including a base sleeve fixedly connected to said base plate, wherein said base sleeve receives said lower arm.

10. The work surface assembly of claim 1, wherein said support assembly is rotatable relative to said telescoping arm assembly.

11. The work surface assembly of claim 1, further comprising a container for receiving said work surface assembly, said work surface assembly being mounted within said container with said work surface assembly being telescopically moveable between a raised position with said support assembly positioned outside of said container and a lowered position with said support assembly positioned inside of said container.

12. The work surface assembly of claim 11, wherein said container includes a lid and wherein said lid is closeable to secure said work surface assembly within said container when said work surface assembly is in the lowered position.

13. The work surface assembly of claim 12, wherein said container is mounted adjacent a driver seat of a vehicle.

14. A vehicle with a work surface apparatus to provide a work surface comprising:
a seat in which an individual sits for operation of the vehicle;
a container, said container being mounted to said vehicle adjacent said seat; and
a work surface assembly mounted within said container, said work surface assembly comprising a support assembly affixed to a telescoping arm assembly;
said telescoping arm assembly including an upper arm configured for telescopic movement relative to a lower arm whereby said support assembly may be raised and lowered with said support assembly including a first support member, said first support member being horizontally oriented and mounted to said telescoping arm assembly whereby said first support member may be raised to project out of said container and lowered to be retained inside of said container.

15. The vehicle of claim 14, wherein said first support member is slidingly mounted to said telescoping arm assembly whereby said first support member may be radially extended and retracted relative to said telescoping arm assembly.

16. The vehicle of claim 17, wherein said telescoping arm assembly includes a mounting plate connected with said upper arm, and wherein said first support member is mounted to said mounting plate.

17. The vehicle of claim 16, further including a slide assembly, said slide assembly being connected to said mounting plate and said first support member to enable said first support member to radially extend and retract relative to said telescoping arm assembly.

18. The vehicle of claim 14, further including a second support member located adjacent said first support member, wherein said second support member may be vertically or horizontally oriented.

19. The vehicle of claim 14, wherein said telescoping arm assembly further includes a base plate distally located from said support assembly, said base plate adapted for mounting said work surface assembly.

20. The vehicle of claim 19, further including a base sleeve fixedly connected to said base plate, wherein said base sleeve receives said lower arm, and wherein said support assembly is rotatable relative to said telescoping arm assembly.
